(19) United States
(12) Patent Application Publication
(10) Pub. No.: US 2008/0210369 A1
(43) Pub. Date: Sep. 4, 2008

(54) METHOD FOR LAMINATING A LOW-PARTICLE FILM TUBE

(76) Inventors: Thomas Nicola, Spicheren (FR); Martin Schmidtlein, Marpingen (DE)

Correspondence Address: Muncy, Geissler, Olds & Lowe, PLLC, P.O. BOX 1364, FAIRFAX, VA, 22038-1364, US

(21) Appl. No.: 11/944,598

(22) Filed: Nov. 23, 2007

Related U.S. Application Data
(63) Continuation of application No. PCT/EP2006/004880, filed on May 23, 2006.

(30) Foreign Application Priority Data
May 23, 2005 (DE) DE 102005024150

(51) Int. Cl. B29C 47/00

(52) U.S. Cl. 156/244.13; 264/129

(57) ABSTRACT

A method for producing an extrusion-laminated or heat-laminated extruded film tube is described, in which the film tube is provided with a functional layer.

This nonprovisional application is a continuation of International Application No. PCT/EP2006/004880, which is filed on May, 23,2006, and which claims priority to German Patent Application No. DE 102005024150, which was filed in Germany on May 23, 2005, and which are both herein incorporated by reference.

### BACKGROUND OF THE INVENTION

1. Field of the Invention

The present invention relates to a method for producing an extrusion-laminated or heat-laminated extruded film tube. The present invention additionally relates to the use of such a film tube for medical applications.

2. Description of the Background Art

Laminated plastic films having more than one layer are known. From these known films, tubes can be produced by heat-sealing. The production of corresponding film tubes is described in EP 0 993 940 A1, for example. For this purpose, a heat-shrinkable, laminated or coated plastic film is produced which on one or both sides has a heat-sealable polyethylene, polypropylene or ethylene/propylene copolymer layer and also a layer of polyethylene terephthalate, polyamide or polypropylene. To produce the film tube, this multi-layer film is then cut into strips which are then shaped, with what is called a “forming shoulder”, into a tube with overlapping longitudinal edges. By the action of pressure and heat applied to the film in a sealing tool, the edges are then fixedly connected to one another. A disadvantage of this method is that several steps are needed for producing a corresponding film tube. First, a suitable film is prepared, for example by extrusion, and is provided then with the corresponding functional coatings. Only after this is the film tube formed, starting from these films provided with the functional layers. This therefore results overall in a production method for the film tube comprising three separate method steps.

In addition, the procedure set out in EP 0 993 940 A1 means that film tubes low in particles or free of particles on the inside, and used for medical applications, can be produced only under very complex operating conditions.

Since the sides lying to the inside of the film tube are initially “open sides” of the plastic films, film tubes that are low in particles or free of particles on the inside are only obtained if all the method steps for producing the film tubes are carried out in clean rooms or if, after production of the film tube, the inside of the latter is flooded with sterile filtered air. However, even under clean-room conditions, it is not possible to exclude the possibility of impurities getting into the interior of the film tubes because of the electrostatic charge of the film tubes.

### SUMMARY OF THE INVENTION

It is therefore an object of the present invention to provide a method for producing a film tube by means of which a film tube with a functional layer is made available in an economic and simple manner, the inside of the film tube preferably being sterile, and the functional layer having a low permeability for water vapour and gas.

This object is achieved, in a first embodiment, by a method for producing an extrusion-laminated film tube.

The method according to the invention in accordance with this first embodiment can include the following steps:

(a′) producing a laminated film tube by melt extrusion of a plastic;

(b′) optionally cooling the film tube produced in method step (a′);

(c′) coating the optionally cooled film tube with an adhesive layer on at least one side of the film tube;

(d′) optionally drying the film tube provided with the adhesive layer;

(e′) laminating the at least one side of the film tube coated with the adhesive layer with a functional layer;

(f′) optionally drying the laminated film tube.

Therefore, according to the invention, a film tube is in the first place produced by melt extrusion, and the film tube thus obtained is then provided with an adhesive layer preferably directly on at least one side of the film tube. The required functional layer is then applied to this adhesive layer.

Film tubes produced for medical purposes in particular must be free of particles at least in the resulting interior of the film tube. If a coated film tube is produced from single-layer individual coated films, it has, as has already been explained, the disadvantage that the interior of the resulting film tube is not sterile. In the method according to the invention, it is therefore proposed that a film tube is produced in the first place. The two parallel inner sides of the film tube adhere directly to one another after the melt extrusion of the film tube, such that a coating of the outer sides of the film tube is possible with the interior of the film tube closed. The closed interior, which is inflated open in a subsequent use of the resulting film tube, is thus sterile.

In the method according to the invention, it is also possible that the film tube produced in method step (a′) is laminated on both sides. For this purpose, for example, one side of the film tube can be coated with the adhesive, and the film tube coated with the adhesive can then be optionally cooled. The side of the film tube coated with the adhesive is then laminated with a functional layer. Thereafter, the film tube thus laminated on one side can be optionally cooled. Then the second side of the film tube is coated with the adhesive. The film tube coated with the adhesive on the second side can be optionally cooled and then laminated with a further functional layer. The film tube laminated on both sides can then optionally be further subjected to a cooling stage.

In addition, it is also possible that the film tube produced in method step (a′) is laminated on both sides, the coating of the film tube with the adhesive and/or the functional layer taking place at least partially simultaneously on both sides of the film tube.

In the method according to the first embodiment of the invention, an adhesive is preferably used which permits complete setting after approximately 2 weeks. The setting can also take place more rapidly in a heating chamber at elevated temperature, for example at 40° C.

Suitable adhesive materials are isocyanates, polyurethanes, poly(ethylacrylate/methacrylate), pure acrylate copolymers, vinyl ester/acrylate copolymers, or inorganic/organic hybrid polymers, for example as cited in EP 0 882 657 B1.

In another embodiment of the present invention, the adhesive can be chosen such that it meets the requirements of pharmacopoeia limits in respect of migration properties.

Depending on the applied method or the desired coating, the adhesive layer can be applied to one side or to both sides of the film tube produced by co-extrusion. This can be done, for example, by spraying it on or coating it on with a knife. The use of organic or aqueous solutions of the corresponding adhesives is also suitable.

After these adhesive layers have been applied, the resulting film tube can optionally be dried. For example, if the adhesive is applied using an organic solvent or water, the drying can be effected under evaporation of the solvent or the water. The layer thicknesses of the adhesive layers are preferably in the range of 3 to 20 μm.

It is particularly preferable if the adhesive layer thus generated already forms a water barrier and/or gas barrier on the extruded film tube.

In a further embodiment, it is also possible for the adhesive layer to be applied not to the extruded film tube but instead to the functional layer that has been applied to the film tube and is described below.

In the first embodiment of the method according to the invention, the lamination can preferably be carried out by means of lamination rollers or on calenders at room temperature, the contact pressures of the rollers preferably being from 3 to 12 bar, in particular from 5 to 10 bar.

In a second embodiment, the object of the present invention is achieved by a method for producing a heat-laminated extruded film tube.

The method according to this second embodiment of the invention is characterized by the following method steps:

(a″) producing a film tube by melt extrusion of a plastic;

(b″) optionally cooling the film tube produced in method step (a″);

(c″) heat-laminating the optionally dried film tube with a functional layer.

Since heat-laminating of the film tube is provided for in method step (c″), it is preferable if the functional layer is not temperature-sensitive.

Also according to the second embodiment of the method according to the invention, it is possible that the film tube produced in method step (a″) is laminated on both sides. For this purpose, the heat lamination with the functional layer, after production of the film tube by melt extrusion of a plastic and optional cooling of the film tube thus produced, can take place initially on one side and then on the other side of the film tube. It is equally possible that the film tube is heat-laminated with the functional layer at least partially simultaneously on both sides. However, before the lamination on each side, it is preferable that the film tube is laid flat after the cooling.

According to both embodiments of the method according to the invention, it is preferable that, during the laminating process or processes or during the heat lamination(s), the interior of the film remains closed, such that the film interior is very low in particles or free of particles.

In the method according to the first embodiment and second embodiment of the invention, the plastic used in method step (a′) or method step (a″) for producing the film tube is preferably chosen from the group comprising polypropylene, polyethylene copolymers, styrene-ethylene/butylene-styrene block copolymers (SEBS) and styrene-isoprene-styrene block copolymers (SIS).

The method steps involving cooling, and optionally carried out in both embodiments of the present method, can, for example, be done by applying air to the outside of the preferably closed film tube. It is also possible to carry out the drying operation in a drying channel.

The production of the film tube according to the invention, by melt extrusion of a plastic, can be carried out in any extruder apparatus known per se to the person skilled in the art. One example of such an apparatus is a single-screw extruder.

According to the first or second embodiment of the present invention, it is preferable for the film tube to travel past a lay-flat device before application of the adhesive, before the lamination with the functional layer and/or before the heat lamination. Alternatively, the film tube can also be laid flat directly after the film extrusion. Then, in a further embodiment, the extruded film tube can be wound up and then laminated.

In a particularly preferred embodiment, the film tube has a thickness of 50 to 300 μm.

In both embodiments of the present method, the film tube produced by melt extrusion of a plastic is provided with a functional layer. This functional layer preferably has the effect that the resulting film tube, i.e. the coated film tube, is made gas-tight and/or water-tight.

If the functional layer is intended to produce a film tube that is gas-tight, then the functional layer used can, for example, be an ethylene-vinyl alcohol copolymer, a polyvinyl alcohol, a polyvinylidene chloride (PVDC), a polyamide, a liquid-crystalline polymer (LCP), SiOx, AlOx, or an acrylate-based coating.

If the functional layer is intended to produce a film tube that is water-tight, then the functional layer used can, for example, be a polyvinylidene chloride (PVDC), a liquid-crystalline polymer (LCP), SiOx or AlOx.

The functional layer preferably has a layer thickness of 5 to 120 μm.

In addition, it is possible that the film tube provided with the functional layer is provided with further films subsequent to the method according to the invention. Examples of these are plastic cover films, which can be water-insoluble and/or insoluble in organic solvents.

The protruding edges of the coated film tubes resulting from the production methods of the first or second embodiment can also be trimmed. This can be done using a hot blade, for example.

The multi-layer composite films according to the invention can be transparent to opaque, translucent, or rendered impervious to light by means of pigments or colours, for example if pigments that can be colored or dyes are incorporated into the functional layer.

In many cases it may be preferable, in the method according to the first embodiment of the invention, if the adhesive layer is applied to one side of the functional layers instead of to both sides of the film layers.

In a preferred embodiment of the present invention, the inside of the film tube is preferably low in particles, particularly preferably free of particles, and in particular sterile.

The invention further relates to the use of film tubes, produced according to the first and second embodiments of the invention, for medical purposes, for example as infusion bags, packages, bags containing irrigation solution, bags containing dry concentrate, bags for parenteral nutrition, and bags for enteral nutrition. The respective film tubes can also be used as multi-chamber bags.

The present invention is explained on the basis of the following illustrative embodiment, which illustrative embodiment does not limit the invention.

### DETAILED DESCRIPTION OF AN EXEMPLARY EMBODIMENT

The following materials may be used in an exemplary emodiment:

a) Film tube: Co-extruded three-layer film tube of 470 mm width and 120 μm thickness, in which the outer layer can be made from a polypropylene (HC101BF, Borealis), the middle layer from a polymer comprising 40% polypropylene (RD208CF, Borealis) and 60% styrene-ethylene/butylene-styrene copolymer (Tuftec H1062, Asahi), and the inner layer from a polymer comprising 70% polypropylene (RD208CF, Borealis) and 30% styrene-ethylene/butylene-styrene copolymer (Tuftec 1062, Asahi).

b) Functional layer: The functional layer can be a SiOx/PET from Mitsubishi (Techbarrier T).

c) Adhesive agent: The adhesive agent used can be an adhesive produced by Henkel, its main constituent being Linofol UR 3690.

d) Hardener: The hardener used can be Linofol UR 6090 from the Henkel company.

e) Procedure: The film tube made from the aforementioned material can be co-extruded and wound as a flat-laid film tube onto a winding core. In two separate laminating steps, the functional layer is laminated and rolled onto both sides of the flat-laid film tube using the adhesive to which the hardener has been added. After each laminating step, a drying period of one week is observed. The film tube laminated on both sides is then trimmed off at the edges.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a laminated film tube, the method comprising:
(a) producing a film tube by melt extrusion of a plastic, comprising polypropylene, polyethylene copolymers, styrene-ethylene/butylene-styrene block copolymers, styrene-isoprene-styrene block copolymers and/or thermoplastic elastomers (TPE);
(b) optionally cooling the film tube produced in method step (a); and
(c) coating the optionally cooled film tube with a functional layer,
wherein coating (c) is effected by
(c′) coating the optionally cooled film tube with an adhesive layer on at least one side of the film tube;
(d′) optionally drying the film tube provided with the adhesive layer;
(e′) laminating the at least one side of the film tube coated with the adhesive layer with a functional layer;
(f′) optionally drying the laminated film tube,
or by
(c″) heat-laminating the optionally dried film tube with a functional layer.

2. The method for producing an extrusion-laminated film tube according to claim 1, comprising the following method steps:
(a′) producing a film tube by melt extrusion of a plastic;
(b′) optionally cooling the film tube produced in method step (a′);
(c′) coating the optionally cooled film tube with an adhesive layer on at least one side of the film tube;
(d′) optionally drying the film tube provided with the adhesive layer;
(e′) laminating the at least one side of the film tube coated with the adhesive layer with a functional layer;
(f′) optionally drying or curing the laminated film tube.

3. The method according to claim 2, wherein the film tube produced in method step (a′) is laminated on both sides, in which case one side of the film tube is first coated with the adhesive, the film tube coated with the adhesive is then optionally cooled, the side of the film tube coated with the adhesive is then laminated, the film tube laminated on one side is then optionally cooled, and the second side of the film tube is thereafter coated with the adhesive, the film tube coated with the adhesive on the second side is then optionally cooled, the second side of the film tube coated with the adhesive is then laminated, and the film tube laminated on both sides is then optionally cooled or heated.

4. The method according to claim 2, wherein the film tube produced in method step (a′) is laminated on both sides, the coating of the film tube with the adhesive and/or its lamination taking place at least partially simultaneously on both sides of the film tube.

5. The method for producing a heat-laminated film tube according to claim 1, comprising the following method steps:
(a″) producing a film tube by melt extrusion of a plastic;
(b″) optionally cooling the film tube produced in method step (a″);
(c″) heat-laminating the optionally dried film tube with a functional layer.

6. The method according to claim 5, wherein the film tube produced in method step (a″) is heat-laminated on both sides, in which case one side of the film tube is first heat-laminated with the functional layer, then the film tube provided with the functional layer by heat lamination is optionally cooled, and the second side of the film tube is thereafter heat-laminated with a functional layer, and the film tube heat-laminated on both sides is then optionally cooled.

7. The method according to claim 1, wherein, during the laminating process or during the heat lamination, the film interior remains closed.

8. The method according to claim 1, wherein the film tube is laminated or heat-laminated with a functional layer, which renders the film tube gas-tight and/or water-tight.

9. A method of producing infusion bags, packages, dialysis bags, bags containing irrigation solution, bags containing dry concentrate, bags for parenteral nutrition, and bags for enteral nutrition, comprising the step of producing a film tube by the method of claim 1.
